(19) United States
(12) Patent Application Publication
(10) Pub. No.: US 2021/0256357 A1
(43) Pub. Date: Aug. 19, 2021

(54) EMBEDDED STOCHASTIC-COMPUTING ACCELERATOR ARCHITECTURE AND METHOD FOR CONVOLUTIONAL NEURAL NETWORKS

(71) Applicant: University of Louisiana at Lafayette, Lafayette, LA (US)

(72) Inventors: Mohammadhassan Najafi, Lafayette, LA (US); Seved Reza Hojabrossadati, Tehran (IR); Kamyar Givaki, Tehran (IR); S.M. Reza Tayaranian, Tehran (IR); Parsa Esfahanian, Tehran (IR); Ahmad Khonsari, Tehran (IR); Dara Rahmati, Tehran (IR)

(21) Appl. No.: 17/159,347

(22) Filed: Jan. 27, 2021

Related U.S. Application Data
(60) Provisional application No. 62/969,854, filed on Feb. 4, 2020.

(51) Int. Cl. G06N 3/04; G06N 3/063; G06F 7/523

(52) U.S. Cl. CPC G06N 3/0472; G06F 7/523; G06N 3/063

(57) ABSTRACT

The disclosed invention provides a novel architecture that reduces the computation time of stochastic computing-based multiplications in the convolutional layers of convolutional neural networks (CNNs). Each convolution in a CNN is composed of numerous multiplications where each input value is multiplied by a weight vector. Subsequent multiplications are performed by multiplying the input and differences of the successive weights. Leveraging this property, disclosed is a differential Multiply-and-Accumulate unit to reduce the time consumed by convolutions in the architecture. The disclosed architecture offers 1.2× increase in speed and 2.7× increase in energy efficiency compared to known convolutional neural networks.

### CROSS REFERENCE TO RELATED APPLICATIONS

This application claims priority to U.S. Provisional Patent Application No. 62/969,854, titled “Embedded Stochastic-Computing Accelerator for Convolutional Neural Networks”, filed on Feb. 4, 2020.

### STATEMENT REGARDING FEDERALLY SPONSORED RESEARCH OR DEVELOPMENT

Not applicable.

### REFERENCE TO A “SEQUENCE LISTING”, A TABLE, OR COMPUTER PROGRAM

Not applicable.

### DESCRIPTION OF THE DRAWINGS

The drawings constitute a part of this specification and include exemplary examples of the EMBEDDED STOCHASTIC-COMPUTING ACCELERATOR ARCHITECTURE AND METHOD FOR CONVOLUTIONAL NEURAL NETWORKS, which may take the form of multiple embodiments. It is to be understood that in some instances, various aspects of the invention may be shown exaggerated or enlarged to facilitate an understanding of the invention. Therefore, drawings may not be to scale.

FIG. 1 depicts the disclosed differential Multiply-and-Accumulate unit (“DMAC”).

FIG. 2 depicts a logic drawing of the disclosed Architecture.

FIG. 3(a) provides a chart comparison of the network accuracy of the binary implementation versus BISC-MVM for AlexNet and the proposed Architecture, wherein the horizontal axis shows the bitwidth and the vertical axis shows the percentage of accuracy.

FIG. 3(b) provides a chart comparison of the network accuracy of the binary implementation versus BISC-MVM for Inception V3 and the proposed Architecture, wherein the horizontal axis shows the bitwidth and the vertical axis shows the percentage of accuracy.

FIG. 3(c) provides a chart comparison of the network accuracy of the binary implementation versus BISC-MVM for VGG16 and the proposed Architecture, wherein the horizontal axis shows the bitwidth and the vertical axis shows the percentage of accuracy.

FIG. 3(d) provides a chart comparison of the network accuracy of the binary implementation versus BISC-MVM for MobileNet and the proposed Architecture, wherein the horizontal axis shows the bitwidth and the vertical axis shows the percentage of accuracy.

FIG. 4 provides a table of the synthesis results in 45 nm technology, including area (μm²), critical path latency (ns), power (mW), and energy/cycle (pJ) of a convolution engine (3×3 filter). The results are shown in different bidwidth of the operands (weights and ifmaps).

FIG. 5 provides a table of the performance evaluation of the Architecture. The numbers are normalized to the binary implementation.

FIG. 6(a) provides a graph of the overall speed increase of the Architecture as compared to BISC-MVM (AlexNet). The results are normalized to the binary implementation.

FIG. 6(b) provides a graph of the overall speed increase of the Architecture as compared to BISC-MVM (Inception V3). The results are normalized to the binary implementation.

FIG. 6(c) provides a graph of the overall speed increase of the Architecture as compared to BISC-MVM (VGG16). The results are normalized to the binary implementation.

FIG. 6(d) provides a graph of the overall speed increase of the Architecture as compared to BISC-MVM (MobileNet). The results are normalized to the binary implementation.

FIG. 7(a) provides a graph of the overall energy reduction of the Architecture as compared to BISC-MVM (AlexNet). The results are normalized to the binary implementation.

FIG. 7(b) provides a graph of the overall energy reduction of the Architecture as compared to BISC-MVM (Inception V3). The results are normalized to the binary implementation.

FIG. 7(c) provides a graph of the overall energy reduction of the Architecture as compared to BISC-MVM (VGG16). The results are normalized to the binary implementation.

FIG. 7(d) provides a graph of the overall energy reduction of the Architecture as compared to BISC-MVM (MobileNet). The results are normalized to the binary implementation.

### FIELD OF THE INVENTION

The field of the invention is computer vision in the realm of convolutional neural networks. Specifically, this invention relates to stochastic computing architectures in convolutional neural networks.

### BACKGROUND OF THE INVENTION

Convolutional neural networks (CNNs) are specialized neural network models designed primarily for use with two-dimensional image data. Central to the CNN is a convolutional layer that provides the convolution operation. Convolution is a linear operation that comprises multiplying a set of weights with an input, similar to a traditional neural network. Multiplication is performed here between an array of input data and an array of weights, known as a filter or kernel.

Several applications based on CNNs have emerged in the computer vision field. Particularly, use of CNNs in intelligent embedded devices interacting with real-world environment has led to the advent of efficient CNN accelerators. Two important challenges in using neural networks in embedded devices are limited computational resources and inadequate power budgets. To address these challenges, development in the realm of customized hardware implementation has increased.

Recently, a number of works have exploited stochastic computing (SC) in designing low-cost CNN accelerators. See M. Alawad and M. Lin, Stochastic-based deep convolutional networks with reconfigurable logic fabric, IEEE Transactions on multi-scale computing systems 4 (2016), 242-256; S. R. Faraji, M. H. Najafi, B. Li, K. Bazargan, and D. J. Lilja, Energy-Efficient Convolutional Neural Networks with Deterministic Bit-Stream Processing, Design, Automation, and Test in Europe (2019); V. T. Lee, A. Alaghi, J. P. Hayes, V. Sathe, and L. Ceze, Energy-efficient hybrid stochastic-binary neural networks for near-sensor computing, Design, Automation, and Test in Europe Conference & Exhibition (2017), IEEE, 13-18; B. Li, M. H. Najafi, and D. J. Lilja, Low-Cost Stochastic Hybrid Multiplier for Quantized Neural Networks, J. Emerg. Technol. Comput. Syst., 15,2, Article 18 (March 2019), 18: 1-18: 19; Ji Li, Ao Ren, Zhe Li, Caiwen Ding, Bo Yuan, Qinru Qiu, and Yanzhi Wang, Towards acceleration of deep convolutional neural networks using stochastic computing, ASP-DAC (2017), 115-120; Y. Liu, Y. Wang, F. Lombardi, and J. Han, An energy-efficient stochastic computational deep belief network, Design, Automation & Test in Europe Conference & Exhibition (2018), IEEE, 1175-1178; A. Ren, Z. Li, C. Ding, Q. Qui, Y. Wang, J. Li, X. Qian, and B. Yuan, Sc-dcnn: Highly-scalable deep convolutional neural network using stochastic computing,ACM SIGOPS Operating Systems Review 51, 2 (2017); H. Sim, S. Kenzhegulov, and J. Lee, DPS: dynamic precision scaling for stochastic computing-based deep neural networks, Proceedings of the 55th Annual Design Automation Conference, ACM (2018), 13; H. Sim and J. Lee, A new stochastic computing multiplier with application to deep convolutional neural networks, Design Automation Conference (DAC), 2017 54th ACM/EDAC/IEEE, IEEE, 1-6.

Compared to conventional binary implementations, SC-based implementations offer lower power consumption, lower hardware area footprint, and a higher tolerance to soft errors (i.e., bit flips). In SC, each number X (that is interpreted as the probability P(x) in range [0,1]), is represented by a bit-stream in which the density of the 1 s denotes P(x). For instance, a binary number X=0.101₂ that is interpreted as P(x)=5/8, can be represented by a bit-stream S=11101001 where the number of 1 s appearing in the bit-stream and the length of the bit-stream are five and eight, respectfully. Bit-stream-based representation makes SC numbers more tolerable to the soft errors as compared to conventional binary radix representation. A single bit-flip in binary representation may lead to a large error, while in a SC bit-stream can cause only a small change in value.

Simplicity of design is another important advantage. Most arithmetic operations require extremely simple logic in SC. For example, multiplication operation is performed using a single AND gate, which has a considerably lower hardware cost than a binary multiplier.

Despite these benefits, SC-based operations have two problems: (1) low accuracy; and (2) long computation time. Prior works in the art showed that, due to the approximate nature of neural networks, CNN accelerators can be implemented by low-bitwidth binary arithmetic units at no accuracy loss. See Y. Chen, T. Krishna, J. Emer, and V. Sze, Eyeriss: An Energy-Efficient Reconfigurable Accelerator for Deep Convolutional Neural Networks, IEEE International Solid-State Circuits Conference, ISSCC (2016), 262-63; H. Sharma, J. Park, N. Suda, L. Lai, B. Chau, V. Chndra, and H. Esmaeilzadeh, Bit Fusion: Bit-Level Dynamically Composable Architecture for Accelerating Deep Neural Network, 2018 ACM/IEEE 45 Annual Symposium on Computer Architecture(ISCA), IEEE; S. Zhou, Y. Wu, Z. Ni, X. Zhou, H. Wen, and Y. Zou, DoReFa-Net: Training low bitwidth convolutional neural networks with low bitwidth gradients (2016), arXiv preprint arXiv:1606.06160. The inventors have also observed that, similar to binary implementations, with long enough bit-streams, SC-based units do not impose a considerable degradation on the neural network accuracy. Nevertheless, there is still demand to decrease the computation time and to improve the energy efficiency of SC-based CNN accelerators.

Efficient hardware accelerators for CNNs have become a frequently debated topic. Most of the recently proposed hardware use low-bitwidth arithmetic units in their datapaths as CNNs are inherently tolerant of bit-width variations. See T. Chen, Z. Du, N. Sun, J. Wang, C. Wu, Y. Chen, and O. Temam, Diannao: A small-footprint high throughput accelerator for ubiquitous machine learning, ACM Sigplan Notices 49, 4 (2014), 269-284; H. Sharma, J. Park, N. Suda, L. Lai, B. Chau, V. Chndra, and H. Esmaeilzadeh, Bit Fusion: Bit-Level Dynamically Composable Architecture for Accelerating Deep Neural Network, 2018 ACM/IEEE 45 Annual Symposium on Computer Architecture (ISCA), IEEE; A. Yasoubi, R. Hojabr, and M. Modarressi, Power-efficient accelerator design for neural networks using computation reuse, IEEE Computer Architecture Letters 16, 1 (2017), 72-75. This eliminates the need for costly full-precision arithmetic units. Eyeriss proposed a dataflow to minimize the power consumption of data accesses needed in the computations by exploiting the data reuse pattern in the inputs and weights of a layer. Y. Chen, T. Krishna, J. Emer, and V. Sze, Eyeriss: An Energy-Efficient Reconfigurable Accelerator for Deep Convolutional Neural Networks, IEEE International Solid-State Circuits Conference, ISSCC (2016), 262-63. Stripes introduced a bit-serial inner-product engine that dynamically tunes the precision of computations to maximize energy savings and performance at the cost of a slight loss in the network accuracy. See P. Judd, J. Albericio, T. Hetherington, T. M. Aamodt, and A. Moshovos, Stripes: Bit-serial deep neural network computing, 2016 49th Annual IEEE/ACM International Symposium on Microarchitecture (MICRO), IEEE. To reduce the computation load in the activation units (each convolution layer is usually followed by an activation layers), SnaPEA proposed a heuristic approach for early prediction of the activation units output. See V. Akhlaghi, A. Yazdanbakhsh, K. Samadi, H. Esmaeilzadeh, and R. Gupta, SnaPEA: Predictive early activation for reducing computation in deep convolutional neural networks (2018), ISCA. Other works have been done on the sparsity in convolution layers to reduce the power consumption by eliminating unnecessary multiplications where at least one of the operands is zero. See A. Parashar, M. Rhu, A. Mukkara, A. Puglielli, R. Venkatesan, B. Khailany, J. Emer, S. W. Keckler, and W. J. Dally, SCNN: An accelerator for compressed-sparse convolutional neural networks, Computer Architecture (ISCA), 2017 ACM/IEEE 44th Annual International Symposium on, IEEE (2017), 27-40; S. Zhang, Z. Du, L. Zhang, H. Lan, S. Liu, L. Li, Q. Guo, T. Chen, and Y. Chen, Cambricon-X: An accelerator for sparse neural networks, Microarchitecture (MICRO), 2016 49th Annual IEEE/ACM International Symposium on, IEEE (2016), 1-12.

Though recently proposed architectures strove to reduce power consumption with minimal degradation in performance, utilizing them in embedded systems is still limited due to tight energy constraints and insufficient processing resources. SC is an appealing alternative design method to conventional binary design that not only meets the energy constraints of embedded devices but also is implemented via ultra low-cost hardware resources.

Recent efforts have been made to implement SC accelerators for CNNs. H. Sim and J. Lee introduced a new SC multiplication algorithm, known as BISC-MVM, for matrix-vector multiplication. See H. Sim and J. Lee, A new stochastic computing multiplier with application to deep convolutional neural networks, Design Automation Conference (DAC), 2017 54th ACM/EDAC/IEEE, IEEE, 1-6. Ji Li, Ao Ren, Zhe Li, Caiwen Ding, Bo Yuan, Qinru Qiu, and Yanzhi Wang proposed a fully parallel and scalable architecture for CNNs. See Ji Li, Ao Ren, Zhe Li, Caiwen Ding, Bo Yuan, Qinru Qiu, and Yanzhi Wang, Towards acceleration of deep convolutional neural networks using stochastic computing, ASP-DAC (2017), 115-120. The impact of low-bitwidth operations on the accuracy of SC-based CNNs has also been investigated. See H. Sim, S. Kenzhegulov, and J. Lee, DPS: dynamic precision scaling for stochastic computing-based deep neural networks, Proceedings of the 55th Annual Design Automation Conference, ACM (2018), 13. A dynamic precision scaling method that achieves significant improvements over conventional binary implementations has also been developed.

The disclosed invention makes use of stochastic logic. In stochastic logic, numbers are represented using random or unary bit streams where each bit is of same weight. In the unipolar format, stochastic numbers (SNs) are interpreted as probabilities in the [0,1] interval. In convolution computation, the inputs are the values of a feature map (commonly integers in the range [0,255]). So, a pre-processing step is required to scale the numbers to the [0,1] interval. This is done by dividing the input numbers by 256. For instance, the input number x=23 in the conventional binary domain is replaced by the number xₛ=23/256 in the stochastic domain. The values of the weight vectors are typically in the range [−1,1], so there is no need to scale the weights when multiplying them by the inputs.

SNs are represented by streams of random (or unary) bits where the ratio of the number of ones to the length of the bit-stream determines the value in the [0,1] interval. Multiplication, as an essential operation in CNNs, is performed by bit-wise ANDing of SNs (bit-streams). This results in a significant reduction in the hardware costs compared to the conventional binary multiplier. Provided that X and Y are statistically independent (uncorrelated), a single AND gate can precisely compute X·Y.

Converting binary numbers (BNs) to SNs and vice-versa are the primary steps in SC operations. A BN-to-SN converter (i.e., Stochastic Number Generator or SNG) is often composed of a binary comparator and a linear feedback shift register (LFSR) as the random number generator (RNG). Employing different LFSRs (i.e., different feedback functions and different seeds) in generating SNs leads to producing sufficiently random and uncorrelated SNs. To convert an SN to BN it suffices to count the number of 1 s in the bit-stream. Therefore, a binary counter is a straightforward circuit for SN to BN conversion.

### SUMMARY OF THE INVENTION

Disclosed herein is an architecture for an SC accelerator for CNNs that effectively reduces the computation time of the convolution by faster multiplication of bit-streams by skipping the unnecessary bitwise ANDs. The time saving due to using the proposed bit skipping approach further improves the energy consumption (i.e., power x time) compared to the state-of-the-art design.

The novel SC-based architecture (“Architecture”) is designed to reduce the computation time of stochastic multiplications in the convolution kernel, as these operations constitute a substantial portion of the computation loads in modern CNNs. Each convolution is composed of numerous multiplications where an input xᵢ is multiplied by successive weights w₁, . . . . wₖ. Computation time of SC-based multiplications is proportional to the bit-stream length of the operands. Provided by maintaining the result of (xᵢ×w₁), to calculate the term xᵢ×w₂, xᵢ×(w₂−w₁) can be calculated and the result added to xᵢ×w₁ that is already prepared. Employing this arithmetic property results in a considerable reduction in the multiplication time as the length of w₂−w₁ bit-stream is less than the length of w₂ bit-stream in the developed architecture. A differential Multiply-and-Accumulate unit, hereinafter “DMAC”, is used to exploit this property in the Architecture. By sorting the weights in a weight vector, the Architecture minimizes the differences between the successive weights and consequently, minimizes the computation time and energy consumption of multiplications.

The disclosed Architecture provides three key improvements. First, disclosed is a novel SC accelerator for CNNs, which employs SC-based operations to significantly reduce the area and power consumption compared to binary implementations while preserving the quality of the results. Second, the Architecture comprises the DMAC to reduce computation time and energy consumption by using the differences between successive weights to improve the speed of computations. Employing the DMAC further omits the overhead cost of handling negative weights in the stochastic arithmetic units. Third, evaluating the Architecture's performance on four modern CNNs shows an average of 1.2 times increase in speed and 2.7 times the energy saving compared to the conventional binary implementation.

### DETAILED DESCRIPTION OF THE INVENTION

Stochastic multiplication of random bit-streams often takes a very long processing time (proportional to the length of the bit-streams) to produce acceptable results. A typical CNN is composed of a large number of layers where the convolutional layers constitute the largest portion of the computation load and hardware cost. Due to the large number of multiplications in each layer, developing a low-cost design for these heavy operations is desirable. The BISC-MVM method disclosed by Sim and Lee significantly reduces the number of clock cycles taken in the stochastic multiplication and the total computational time of convolutions, but further improvement to mitigate the computational load of multiplications is still needed.

In convolutional layers known in the art, each filter consists of both positive and negative weights. The conventional approach to handle signed operations in the SC-based designs is by using the bipolar SC domain. The range of numbers is extended from [0,1] in the unipolar domain to [−1, 1] in the bipolar domain at the cost of doubling the length of bit-streams and so doubling the processing time.

Prior developments in the art proposed to divide the weights into negative and positive subsets and employ unipolar SC operations for each subset instead of using bipolar SC. Although employing this approach eradicates the cost of bipolar SC operations, it requires duplicating most parts of the operational circuits such as multipliers and adders. Since the differences of the sorted successive weights are always greater than zero, the weight buffer in the Architecture consists of only positive numbers. Thus, the Architecture eliminates the need for separating the computations of negative and positive weights.

A filter of size C×k×k in a convolutional layer is composed of C channels, each channel is a 2D vector of size k×k. Convolution is an inner-product where each input value xᵢ in the ifmaps (input feature maps) is multiplied by the weights of the corresponding filter channel (w₁, w₂, . . . , w_{k×k}). So, each multiplication has an operand xᵢ in common with the other multiplications (xᵢ×w₂), . . . , (xᵢ×w_{k×k}). In the BISC-MVM architecture, the computation of xᵢ×wⱼ takes wⱼ clock cycles (xᵢ is fed to the SNG and the down counter is initially set to wⱼ). To multiply xᵢ by the successive weights of the filter, provided by maintaining the result of the first multiplication (xᵢ x w₁), the next weight can be calculated using the following equation: (xᵢ×w₂)=xᵢ×w₁+xᵢ×(w₂−w₁).

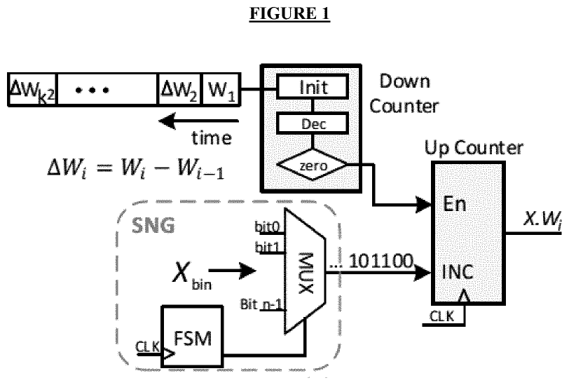

When (w₂−w₁) is less than w₂, the multiplication time reduces from w₂ to (w₂−w₁) clock cycles. FIG. 1 illustrates the microarchitecture of the disclosed DMAC. DMAC unit comprises of a weight buffer, a down counter, an up counter, and an SNG unit which includes a multiplexer (MUX) and a finite-state-machine (FSM). Note that the points xᵢs located in the border of the ifmaps are multiplied by a subset of the weights of the filter and this leads to a lower improvement compared to other points. However, the number of these points is far less than the number of inner points, so the impact is negligible.

Minimizing the differences between successive values in the weight vector leads to further reduction in the computation time of the multiplications. To this end, the weights of a filter are reordered, with the weights vector filled in ascending order. The reordering minimizes the differences in successive weights. When the weights are reordered, an index buffer is also used to hold the indices of the weights in the original filter.

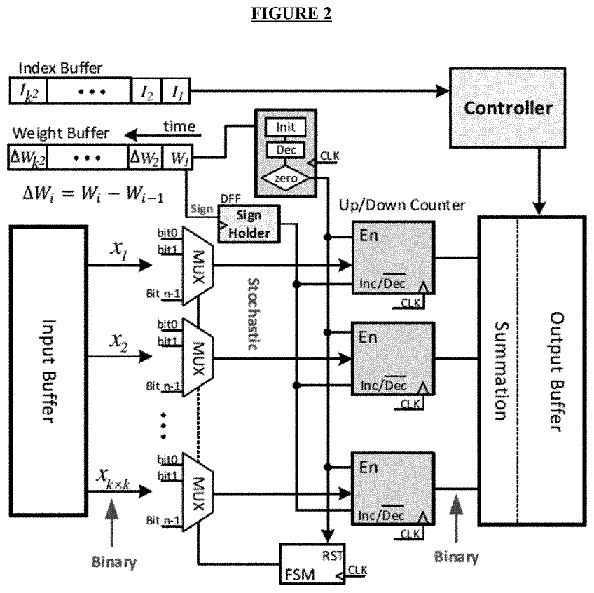

The Architecture provides an accelerator capable of performing a 2D convolution more efficiently than methods and architecture known in the art. A high-level block diagram for the Architecture is depicted in FIG. 2. As seen in FIG. 2, the Architecture comprises a controller, an input buffer, an output buffer, and an accelerator. The controller is configured to manage the timing and organize the Architecture operation. The input buffer fetches the needed input data from the main memory, and the output buffer stores the corresponding results of each convolution. The accelerator comprises the following dedicated units: index and weight buffers; a BN-to-SN Converter (SNG); a sign holder; one or more counters; and a summations unit.

Index and weight buffers. To minimize the differences between successive weights, the weights must be sorted. This sorting is done offline and the sorted weights are loaded into the weight buffer. Since there is no priority among multiplications in a convolution, this reordering does not have any impact on the output. However, the controller is aware of the proper ordering using the index buffer. In every cycle, the controller fetches a weight and broadcasts it to all the counters. After completing the multiplications, the controller stores the result corresponding to each index.

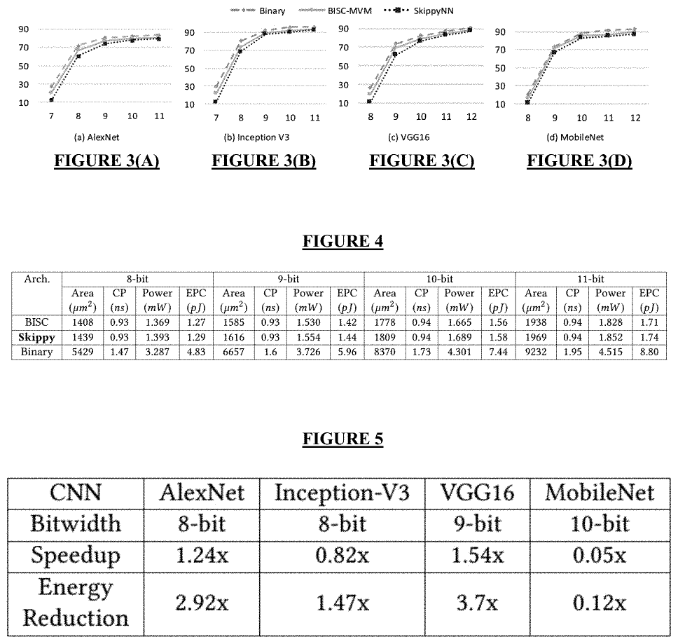

BN-to-SN converter (SNG). Since the ifmaps are entirely independent of each other, there is no need to guarantee that the generated SNs are uncorrelated. Given this insight, a single FSM is shared among the SNGs of all the input operands (ifmaps) to control all of the multiplexers. As shown in FIG. 4, the process of generating the bit-streams is terminated when the down-counter reaches its zero state.

Sign holder. Typically, the weights of the filters are bipolar and in the [−1, 1] interval. Therefore, the accelerator architecture should support signed multiplication. To this end, up/down counters are used for multiplication to be able to either increase or decrease the output. In each cycle, if the weight is negative, the counter counts in descending order; otherwise, the counter counts in ascending order. Note that the inputs to the convolution layers are always positive. In the first layer, the input data is the pixels of an image and greater than zero. Each convolutional layers in modern (CNNs) is followed by a Rectified Linear Unit (“ReLU”) activation function. The ReLU activation function returns zero for the negative inputs and returns the input itself (unchanged) when the input is greater than zero. Thus, the intermediate ifmap values (inputs to the middle convolutional layers) are also positive.

When using the differences of successive weights (instead of the original weights), all values in the weight buffer are positive except for the first value. After sorting the weights in ascending order, the first value of the weight buffer is the smallest weight, which is typically a negative value. The remaining values are all positive (w₂>w₁⇒w₂−w₁>0). To support the first bipolar multiplication, the Architecture is equipped with a sign holder unit comprising a D-flipflop gate that holds the sign of the first value. The sign holder is connected to the Inc/Dec input of the counters to determine if they should count upwards or downwards.

Counters and summation unit. The designated counters are used to multiply ifmaps by the weights and convert the results to BNs simultaneously. The counters are followed by a summation unit which adds the results of the multiplications with respect to the original order of the weights.

The performance of the Architecture has been tested using four modern CNNs known in the art: AlexNet, VGG16, Inception-V3, and MobileNet. First, the network accuracy is analyzed. Second, the synthesis results of the hardware implementation of the Architecture is evaluated. Last, the increase in speed of the Architecture is compared to BISC-MVM and conventional binary implementation.

First, evaluating network accuracy, FIG. 3 shows the accuracy of the Architecture versus BISC-MVM and conventional binary implementation for different bitwidths. Caffe was used to measure the overall accuracy of the networks by processing 10,000 randomly selected images from ImageNet. See for Caffe, Y. Jia, E. Shelhamer, J. Donahue, S. Karayev, J. Long, R. Girshick, S. Guadarrama, and T. Darrell, Caffe: Convolutional architecture for fast feature embedding, Proceedings of the 22nd ACM international conference on multimedia (2014), 675-78. The training process was executed offline to extract the network parameters. The uncertainty of SC-based multipliers caused no considerable accuracy loss due to the inherent tolerance of neural networks to inaccuracy in the computations. Experimental results showed that the accuracy of the Architecture is comparable to conventional binary implementation.

To next evaluate the hardware costs of the Architecture, a cycle-accurate micro-architectural simulator was developed in RTL Verilog. Synthesis results were extracted by the Synopsys Design Compiler using a 45 nm technology library and measured for different bitwidths in the Architecture, BISC-MVM, and conventional binary implementation. As shown in FIG. 4, due to the simpler arithmetic units, SC-based implementations see significant improvement in the area, working frequency, and power consumption. The Architecture delivers, on average, 4.4× improvement in the energy/cycle (the product of critical path latency and power consumption) compared to binary implementation. As the bitwidth gets longer, the working frequency of the binary convolution engine decreases. The working frequency of SC-based implementations, however, remains relatively unchanged as the complexity of stochastic design is independent of the precision of data.

Comparing the Architecture to the BISC-MVM in terms of area and power consumption, the proposed architecture has a slightly higher hardware cost due to using an index buffer to hold the indices of weight. Considering the improvement in processing time, this slightly higher hardware cost is negligible.

The main challenges of applying SC-based convolution engines in hardware accelerators are the high processing time and energy consumption. Processing time is obtained by multiplying the number of clock cycles taken in a convolution and the critical path latency. FIG. 6 shows the increased speed of the Architecture and BISC-MVM as compared to binary implementation. The Architecture uses the differences of reordered weights and hence, takes fewer number of cycles than BISC-MVM. Comparing the processing time of the Architecture and the binary can vary, but as seen in FIG. 6, the Architecture in some cases has shown a lower processing time than the conventional binary implementation. This result is due to the bitwidth. As the bitwidth gets shorter, the weights get closer together (since they are being scaled down to a lower range). Hence, the differences of successive weights and the number of cycles required decreases, causing a lower processing time for the Architecture for certain CNNs.

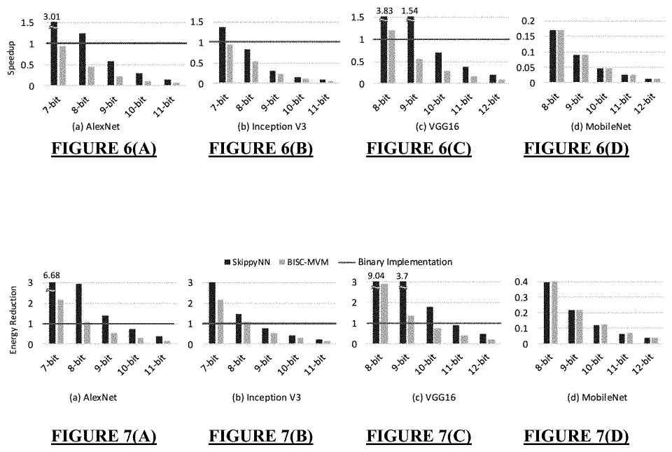

Energy consumption is evaluated as the product of the number of clock cycles and the energy per cycle. Similar to processing time, energy reduction from the proposed architecture depends on the filter size and bitwidth. As illustrated in FIG. 7, in some CNNs, the Architecture consumes a lower energy than binary implementation. For instance, in AlexNet, when using 8-bit precision operations, the Architecture offers over 1.2 times energy reduction compared to the binary design while providing acceptable network accuracy.

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies.

Although the terms “step” and/or “block” or “module” etc. might be used herein to connote different components of methods or systems employed, the terms should not be interpreted as implying any particular order among or between various steps herein disclosed unless and except when the order of individual steps is explicitly described.

Furthermore, the described features, structures, or characteristics may be combined in any suitable manner in one or more embodiments. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment. Moreover, the terms “substantially” or “approximately” as used herein may be applied to modify any quantitative representation that could permissibly vary without resulting in a change to the basic function to which it is related.

1. An architecture for performing stochastic multiplication in one or more convolutional layers of a convolutional neural network comprising:
(a) a controller;
(b) an input buffer;
(c) an output buffer; and
(d) an accelerator;
wherein the controller is configured to manage timing and organize the architecture's operation;
wherein the input buffer comprise functionality to fetch one or more inputs from a memory of the neural network; and
wherein the output buffer stores one or more results computed by the architecture.

2. An architecture for performing stochastic multiplication in one or more convolutional layers of a convolutional neural network comprising:
(a) a controller;
(b) an input buffer;
(c) an output buffer; and
(d) an accelerator, comprising:
(i) an index buffer;
(ii) a weight buffer;
(iii) a BN-to-SN converter;
(iv) a sign holder; and
(v) a counters and summation unit;
wherein the controller is configured to manage timing and organize the architecture's operation;
wherein the input buffer comprise functionality to fetch input data from a memory of the computing system; and
wherein the output buffer stores one or more results computed by the architecture.

3. The architecture of claim 2, wherein the weight buffer comprises one or more sorted weights, and wherein the controller comprises knowledge of the sorted weight's proper order.

4. The architecture of claim 2, wherein the controller comprises functionality to fetch one or more weights from the weight buffer and broadcasts said weight the counters and summation unit.

5. The architecture of claim 2, wherein the sign holder comprises functionality to support signed multiplication operations.

6. The architecture of claim 2, wherein the sign holder comprises a D-flipflop gate.

7. The architecture of claim 2, wherein the sign holder is connected to the input of the counters and summation unit.

8. The architecture of claim 2, wherein the counters and summation unit are comprised of two or more counters, and said counters comprise functionality to simultaneously multiply one or more ifmaps by weights and convert one or more results of said multiplication to binary numbers.

9. The architecture of claim 1, further comprising a DMAC unit, comprising:
(a) a weight buffer;
(b) a down counter;
(c) an up counter;
(d) a multiplexer; and
(e) a finite-state-machine.

10. A method of performing stochastic multiplication in one or more convolutional layers of a neural network comprising:
providing a filter comprising two or more weights in the one or more convolutional layers;
storing an indices of the two or more weights' original order in an index buffer;
reordering the two or more weights into ascending order;
populating a weights vector with the two or more weights in ascending order;
providing a controller, wherein said controller manages timing and organization of the stochastic multiplication;
providing an input buffer, wherein said input buffer fetches input data from a memory of the neural network;
providing an output buffer;
providing an accelerator capable of performing two-dimensional convolution;
performing a convolution cycle, wherein the controller fetches one weight from the input buffer and broadcasts said weight to one or more counters in the accelerator;
performing convolutional multiplications; and
storing the one or more results in the output buffer.

11. A method of performing stochastic multiplication in one or more convolutional layers of a neural network comprising:
providing a filter comprising two or more weights in the one or more convolutional layers;
storing an indices of the two or more weights' original order in an index buffer;
reordering the two or more weights into ascending order;
populating a weights vector with the two or more weights in ascending order;
providing a controller, wherein said controller manages timing and organization of the stochastic multiplication;
providing an input buffer, wherein said input buffer fetches input data from a memory of the neural network;
providing an output buffer;
providing an accelerator capable of performing two-dimensional convolution, comprising:
(a) an index buffer;
(b) a weight buffer;
(c) a BN-to-SN converter;
(d) a sign holder; and
(e) a counters and summation unit, comprising one or more counters;
performing a convolution cycle, wherein the controller fetches one weight from the input buffer and broadcasts said weight to one or more counters in the accelerator;
performing convolutional multiplications; and
storing the one or more results in the output buffer.

12. The method of claim 11, wherein the weights vector is stored in the weight buffer.

13. The method of claim 11, wherein the one or more counters comprise an up counter and a down counter.

14. The method of claim 11, wherein the one or more counters count in descending order if the weight fetched by the controller is negative.

15. The method of claim 11, wherein the one or more counters count in ascending order if the weight fetched by the controller is positive.

16. The method of claim 10, wherein the input data to the first convolutional layer is one or more pixels of an image and comprise one or more values greater than zero.

17. The method of claim 11, wherein the sign holder instructs the counters and summations unit whether to count upwards or downwards.

18. The method of claim 11, wherein the one or more counters multiply one or more ifmaps by weights and convert one or more results of said multiplication to binary numbers.

19. The method of claim 18, wherein the one or more counters are followed by the summation unit adding the one or more results with respect to the original order of the weights in the index buffer.
